(19) United States
(12) Patent Application Publication
(10) Pub. No.: US 2009/0268896 A1
(43) Pub. Date: Oct. 29, 2009

(54) INCOMING CALL INFORMATION TRANSMISSION SYSTEM

(75) Inventors: Zse-Hong Tsai, Taipei City (TW); Sin-Hong Liu, Keelung City (TW); Min-Jhe Wu, Taipei County (TW)

Correspondence Address: RABIN & Berdo, PC, 1101 14TH STREET, NW, SUITE 500, WASHINGTON, DC, 20005, US

(73) Assignees: Quanta Computer Inc., Tao Yuan Shien (TW); National Taiwan University, Taipei (TW)

(21) Appl. No.: 12/389,830

(22) Filed: Feb. 20, 2009

(30) Foreign Application Priority Data
Apr. 28, 2008 (TW) 097115605

(51) Int. Cl. H04M 3/42

(52) U.S. Cl. 379/214.01

(57) ABSTRACT

An incoming call information transmission system is provided for transmitting incoming call information called to a first communication device via a first communication system service. The incoming call information transmission system includes a virtual secretary system, a database system, an information management system and an information transmission system. The virtual secretary system records the incoming call information. The database system stores preset account information corresponding to a first account of a second communication system service. The first account is logged in the server system providing the second communication system service via the second communication device. The information management system receives the incoming call information and gets the preset account information by looking up the database system. The information management system further generates a first request command for controlling the information transmission system to transmit the incoming call information to the second communication device via the second communication system service.

This application claims the benefit of Taiwan application Serial No. 97115605, filed Apr. 28, 2008, the subject matter of which is incorporated herein by reference.

### BACKGROUND OF THE INVENTION

1. Field of the Invention

The invention relates in general to an incoming call information transmission system, and more particularly to an incoming call information transmission system capable of transmitting incoming call information called to a first communication device via a first communication system service to a second communication device via a second communication system service.

2. Description of the Related Art

IP private branch exchange (PBX) having Internet protocol (IP) transmission function has been widely used in business telephone system. Normally, the IP PBX is linked to each internal extension of a business telephone system and is further linked to an external telephone system via a network or a public switched telephone network (PSTN). Thus, the IP PBX controls and transfers the telephone communication between internal extensions of a business telephone system and between internal extensions of the business telephone system and external telephones.

Conventionally, the incoming call information management mechanism of a business telephone system is implemented by an IP PBX. For example, when the caller calls an internal extension but is not answered, the IP PBX plays a pre-recorded voice message to guide the caller to leave a voice message. The IP PBX further records the incoming call information (such as the incoming call time, the incoming call number and the indication of a voice message) of the incoming call telephone, and displays the incoming call information on the internal extension. The callee of internal extension can receive the incoming call information when returning to the internal extension.

Conventionally, only when the callee returns to the internal extension will the callee be informed of an un-answered incoming call by the incoming call information management mechanism. Thus, the incoming call information management mechanism of conventional business telephone system cannot provide the incoming call information to the callee in real time.

### SUMMARY OF THE INVENTION

The invention is directed to an incoming call information transmission system and a transmission method thereof. In comparison to conventional incoming call information management mechanism, the incoming call information transmission system of the invention transmits the incoming call information to a communication device specified by the callee in real time, such that the incoming call information is provided in real time.

According to a first aspect of the present invention, an incoming call information transmission system is provided for transmitting incoming call information called to a first communication device via a first communication system service. The incoming call information transmission system includes a virtual secretary system, a database system, an information management system and an information transmission system. The virtual secretary system records the incoming call information. The database system stores preset account information corresponding to a first account of a second communication system service. The first account is logged in the server system providing the second communication system service via the second communication device in response to the first operational event. The information management system receives the incoming call information and gets the preset account information by looking up the database system. The information management system further generates a first request command for controlling the information transmission system to transmit the incoming call information to the second communication device via the second communication system service.

The invention will become apparent from the following detailed description of the preferred but non-limiting embodiments. The following description is made with reference to the accompanying drawings.

### BRIEF DESCRIPTION OF THE DRAWINGS

FIG. 1 shows a block diagram of an incoming call information transmission system according to a first embodiment of the invention;

FIG. 2 shows a detailed block diagram of the information transmission system 18 of FIG. 1;

FIG. 3 shows another block diagram of an incoming call information transmission system according to a first embodiment of the invention;

FIG. 4 shows another block diagram of an incoming call information transmission system according to a first embodiment of the invention;

FIG. 5 shows a block diagram of an incoming call information transmission system according to a second embodiment of the invention; and

FIG. 6A and FIG. 6B show another block diagrams of an incoming call information transmission system according to a second embodiment of the invention.

### DETAILED DESCRIPTION OF THE INVENTION

The present embodiment of the invention provides an incoming call information transmission system which transmits an un-answered incoming call information called to a first communication device via a first communication system service to the second communication device via a second communication system service.

### First Embodiment

When the called-party side communication device cannot communicate with the first communication system service, the incoming call information transmission system of the present embodiment of the invention transmits the incoming call information to the called-party side communication device via the second communication system service.

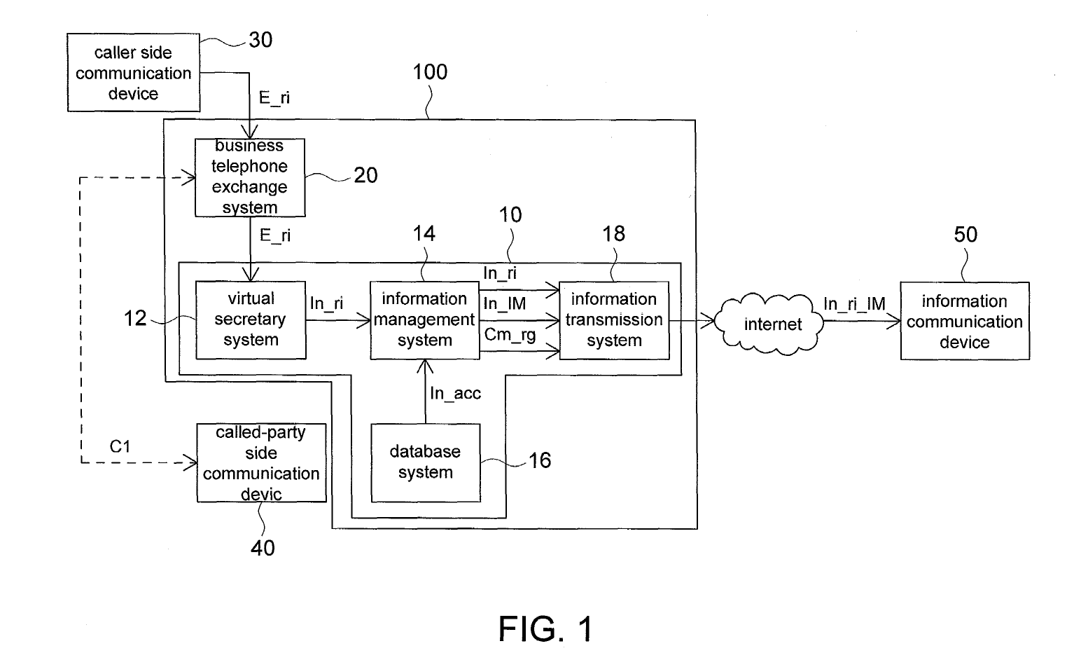

Referring to FIG. 1, a block diagram of an incoming call information transmission system according to a first embodiment of the invention is shown. The incoming call information transmission system 10 includes a virtual secretary system 12, an information management system 14, a database system 16 and an information transmission system 18. The incoming call information transmission system 10 is applied in a communication system 100 having a business telephone exchange system 20. The communication system 100 enables the caller holding the caller side communication device 30 to communicate with the callee holding the called-party side communication device 40. The called-party side communication device 40 supports the first communication system service.

The present embodiment of the invention is exemplified by the scenario that the caller side communication device 30 makes a call to business telephone exchange system 20 via a public switched telephone network (PSTN), and the called-party side communication device 40 is a mobile communication device. The called-party side communication device 40, for example, supports the mobile network communication system and has a corresponding mobile phone number.

The caller side communication device 30 triggers an incoming call event E_ri in response to the caller's operation. The incoming call event E_ri, for example, is an event like the caller makes a call to a business telephone exchange 20 and keys in an extension number corresponding to the extension information. The caller side communication device 30 makes a call to the business telephone exchange 20 via the PSTN. When the caller side communication device 30 triggers the incoming call event E_ri, the business telephone exchange system 20 connects the caller's call.

The virtual secretary system 12 is registered in the business telephone exchange system 20 according to the extension information corresponding to the called-party side communication device 40. On the part of the business telephone exchange system 20, the virtual secretary system 12 is substantially a business internal extension, and the virtual secretary system 12 corresponds to the callee's extension. After the virtual secretary system 12 is registered in the business telephone exchange system 20, the business telephone exchange system 20 further transfers the caller's call to the virtual secretary system 12 in response to the incoming call event triggered by the caller. Thus, the virtual secretary system 12 can communicate with the caller side communication device 30.

The virtual secretary system 12 further makes a mobile phone call to the called-party side communication device 40 via the business telephone exchange system 20 according to the mobile phone number corresponding to the communication device 40. When the callee answers the mobile phone call made by the virtual secretary system 12, a communication link C1 is established between the virtual secretary system 12 and the called-party side communication device 40. Thus, the caller side communication device 30, the virtual secretary system 12 and the called-party side communication device 40 together form a three-party call communication link which enables the caller to communicate with the callee.

However, it happens often in practical application that the communication link C1 cannot be established effectively, and this makes the caller unable to communicate with the callee. For example, it may happen that there is no mobile communication system signal around the called-party side communication device 40 or the callee is in a meeting and has turned off the called-party side communication device 40, so that the communication link C1 cannot be established.

When the communication link C1 cannot be established, the virtual secretary system 12 records the incoming call information In_ri. Examples of the incoming call information In_ri include the telephone number of the caller side communication device 30, the incoming call time, indication of voice message, and so on.

The database system 16 stores the preset account information In_acc, which is established in the database system 16 by the callee. Examples of the preset account information In_acc include a column, in which the callee sets a communication account. The communication account is a communication account of the second communication system service used by the callee. In the present embodiment of the invention, the callee, for example, logs the communication account in the second communication system service through the information communication device 50 to communicate via the second communication system service.

For example, the second communication system service is an instant message (IM) system service, and the communication account is an IM communication account In_IM. The callee, for example, logs in the information communication device 50 to log the IM communication account in the IM server providing IM system service via the information communication device 50. Thus, the callee can operate IM system service via the information communication device 50.

The information management system 14 receives the incoming call information In_ri recorded in the virtual secretary system 12 and gets the IM communication account In_IM by looking up the preset account information In_acc of the database system 16. The information management system 14 further generates a request command Cm_rq for controlling the operation of the information transmission system 18.

The information transmission system 18, in response to request command Cm_rq, transmits the incoming call information In_ri_IM to the information communication device 50 via the IM communication system service according to the IM communication account In_IM. Thus, the incoming call information transmission system 10 of the present embodiment of the invention is capable of transmitting the incoming call information In_ri to the information communication device 50 to inform the callee when the callee is unable to answer the call made by the caller via the called-party side communication device 40.

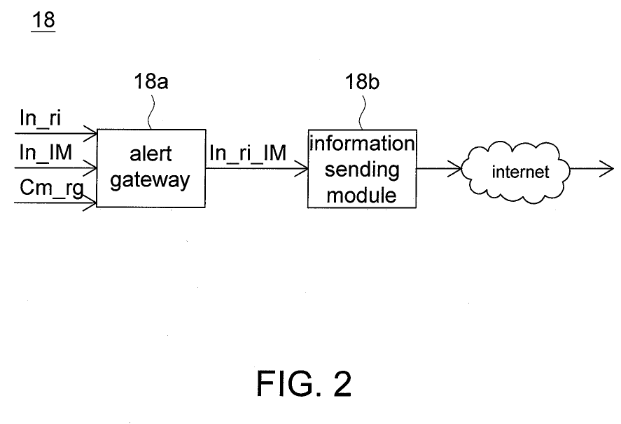

Referring to FIG. 2, a detailed block diagram of the information transmission system 18 of FIG. 1 is shown. The information transmission system 18 includes an alert gateway 18a and an information sending module 18b. The alert gateway 18a, in response to the request command Cm_rq, converts the data format of the incoming call information In_ri to obtain converted incoming call information In_ri_IM. The converted incoming call information In_ri_IM can be transmitted via the IM communication system service.

The information sending module 18b, for example, has another communication account of the IM communication system service. The other communication account is logged in the IM communication system service for enabling the information sending module 18b to operate IM communication. The information sending module 18b receives the incoming call information In_ri_IM provided by the alert gateway 18a, and transmits the incoming call information In_ri_IM via the IM communication system service and the IM server to the IM communication account In_IM logged in the IM communication system service via the information communication device 50. Thus, when the communication link C1 cannot be established effectively, the incoming call information transmission system 10 of the present embodiment of the invention effectively provides the incoming call information In_ri_IM to the information communication device 50 to inform the callee of the incoming call information In_ri.

The present embodiment of the invention is exemplified by the scenario that the called-party side communication device 40 and the information communication device 50 are two different communication devices respectively operating mobile communication and IM communication. However, the called-party side communication device 40 and the information communication device 50 can be integrated into a dual-mode communication device having two communication modules supporting both mobile communication and IM communication.

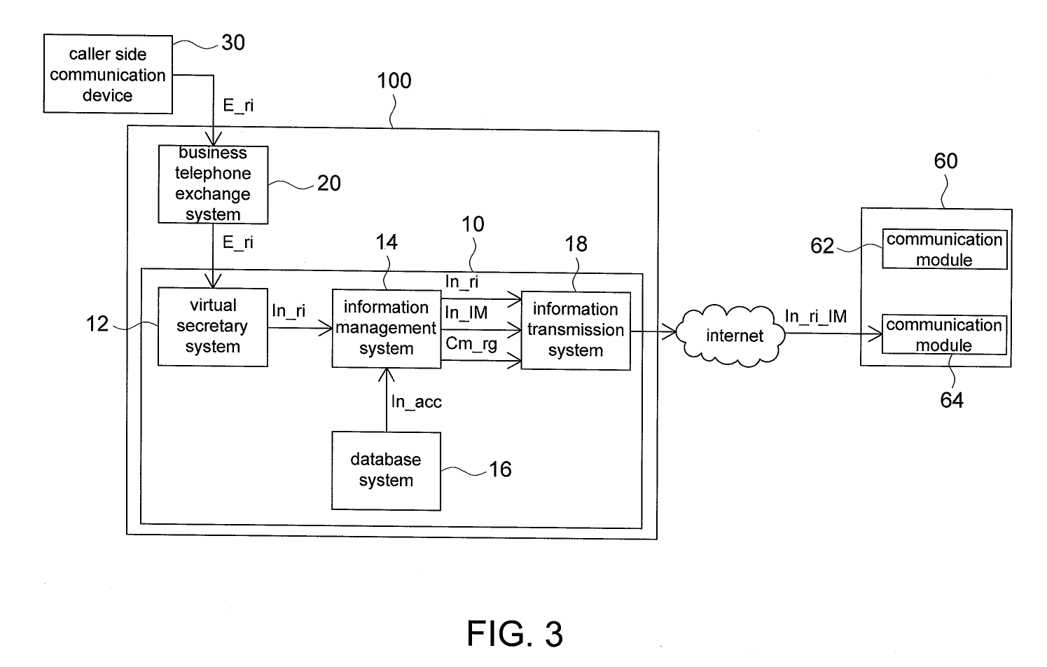

For example, the called-party side communication device 40 and the information communication device 50 of FIG. 1 can be integrated into a dual-mode communication device 60 having communication modules 62 and 64 for respectively supporting mobile communication network service and IM communication network service as indicated in FIG. 3. The callee can selectively turn on the communication module 62 or the communication module 64 of the dual mode communication device 60 to operate mobile phone communication or IM communication. Thus, the incoming call information transmission system 10 of the present embodiment of the invention can provide the incoming call information In_ri_IM to inform the callee through IM communication system and the service the communication module 64 when communication with the callee holding the dual-mode mobile communication device 60 cannot be operated via the communication module 62.

In the present embodiment of the invention, the first and the second communication system service are exemplified by a mobile communication and an IM communication system service respectively. However, the first and the second communication system service are not limited to the mobile communication and the IM communication system service, and other communication system services would do as well.

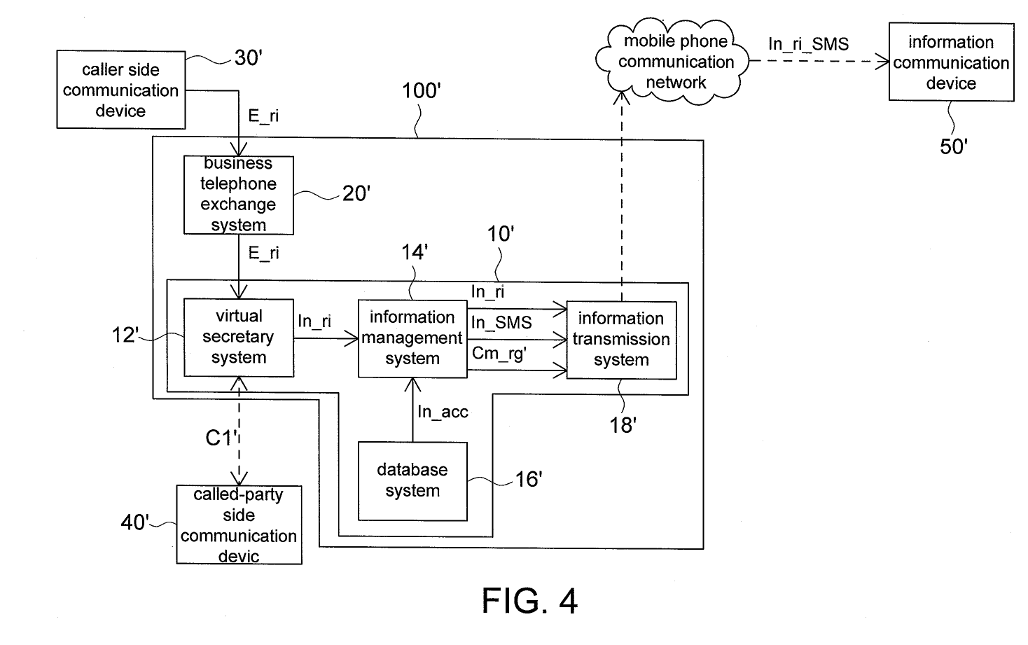

Referring to FIG. 4, another block diagram of an incoming call information transmission system according to a first embodiment of the invention is shown. In another practical operation, the first communication system service is a network phone system service. Meanwhile, the called-party side communication device 40′ is substantially a network phone communication device. Thus, the virtual secretary system 12′ needs to store the network phone communication account corresponding to the called-party side communication device 40 to transfer the call made by the caller side communication device 30′ to the called-party side communication device 40′ via a network.

The second communication system service is a short message service (SMS) for example. Thus, the information communication device 50′ substantially is a mobile phone communication device capable of operating SMS communication. Thus, the column of the preset account information In_acc substantially includes an SMS communication account In_SMS corresponding to the information communication device 50′. The SMS communication account is a mobile phone number for example. The information management system 14′ gets the mobile phone number by looking up the preset account information In_acc and generates a request command Cm_rq′ for enabling the information transmission system 18′ to transmit the incoming call information In_ri_SMS to the information communication device 50′.

When the called-party side communication device cannot communicate with the first communication system service, the incoming call information transmission system of the present embodiment of the invention transmits the incoming call information to the incoming call information communication system via the second communication system service. Thus, in comparison to conventional incoming call information management mechanism, the incoming call information transmission system of the invention transmits the incoming call information to the communication device specified by the callee in real time, such that the incoming call information is provided in real time.

### Second Embodiment

When the called-party side communication device cannot communicate with the first communication system service, the incoming call information transmission system of the present embodiment of the invention transmits the incoming call information to two or more than two communication accounts via the communication system service corresponding to the two or more than two communication accounts.

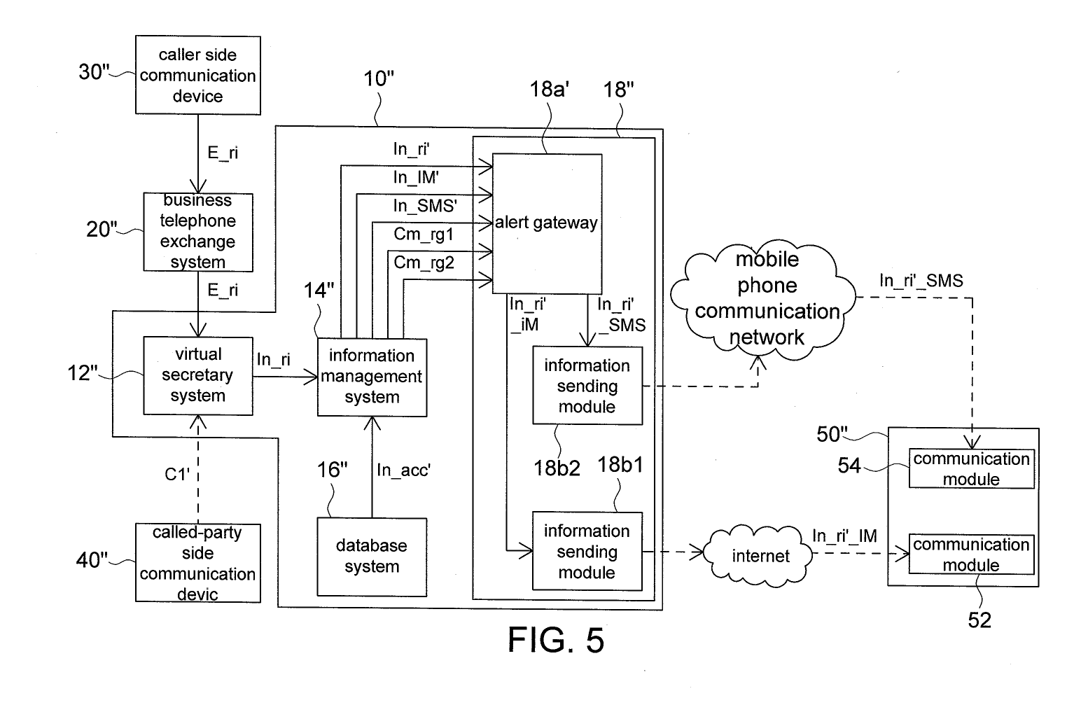

Referring to FIG. 5, a block diagram of an incoming call information transmission system according to a second embodiment of the invention is shown. The incoming call information transmission system 10″ of the present embodiment of the invention differs with the incoming call information transmission system 10 of the first embodiment in that the preset account information In_acc′ stored in the database system 16″ includes two or more than two account information, and the information management system 14″, according to the two or more than two account information, generates two or more than two corresponding request commands for controlling the information transmission system 18″ to transmit the incoming call information In_ri′ via the communication system service corresponding to the two or more than two communication accounts. The incoming call information transmission system 10″ of the present embodiment of the invention differs with the incoming call information transmission system 10 of the first embodiment in that the alert gateway 18a′ of information transmission system 18″ can convert the format of the incoming call information In_ri′ in response to the two or more than two request commands, and the information transmission system 18″ further includes two or more than two information sending modules for operating transmission via two or more than two corresponding communication system services.

For example, the preset account information In_acc′ includes a first and a second column respectively storing an IM communication account In_IM′ and an SMS communication account In_SMS′. The information communication device 50″ of the present embodiment of the invention includes two communication modules 52 and 54, through which the callee operates In_IM′ communication and In_SMS′ communication for the IM communication account and the SMS communication account respectively.

In the present embodiment of the invention, the communication link between the communication module 52 and the incoming call information transmission system 10″ substantially is a wireless region network having a regional range. The incoming call information transmission system 10″ of the present embodiment of the invention judges whether the communication module 52 is inside the regional range by the virtual secretary system 12″ to determine which one of the IM system service and the SMS to operate the transmission of the incoming call information In_ri′.

When the virtual secretary system 12″ judges that the communication module 52 is inside the regional range, the information management system 14″ provides an incoming call information In_ri′, an IM communication account In_IM′ and a request command Cm_rq1 to the alert gateway 18a′ for controlling the alert gateway 18a′ to convert the incoming call information In_ri′ to a converted incoming call information In_ri′_IM, and send the incoming call information In_ri′_IM to the communication module 52 via a corresponding information sending module 18b1.

When the virtual secretary system 12″ judges that the communication module 52 is outside the regional range, the information management system 14″ provides an incoming call information In_ri′, an SMS communication account In_SMS′ and a request command Cm_rq2 to the alert gateway 18a′ for controlling the alert gateway 18a′ to convert the incoming call information In_ri′ to a converted incoming call information In_ri′_SMS, and transmits the incoming call information In_ri′_SMS to the communication module 54 via a corresponding information sending module 18b2.

Thus, the incoming call information transmission system 10″ of the present embodiment of the invention transmits the incoming call information In_ri′ via the communication link corresponding to two or more than two communication accounts when the communication link C1′ cannot be effectively established.

In the present embodiment of the invention, the incoming call information transmission system 10″ judges whether the communication module 52 is inside the regional range by the virtual secretary system 12″ and determines to operate the transmission of the incoming call information In_ri′ via which one of the IM system service and SMS. However, the incoming call information transmission system 10″ of the present embodiment of the invention can also determine to operate the transmission of the incoming call information In_ri′ via which one of the IM system service and SMS according to other judging criteria.

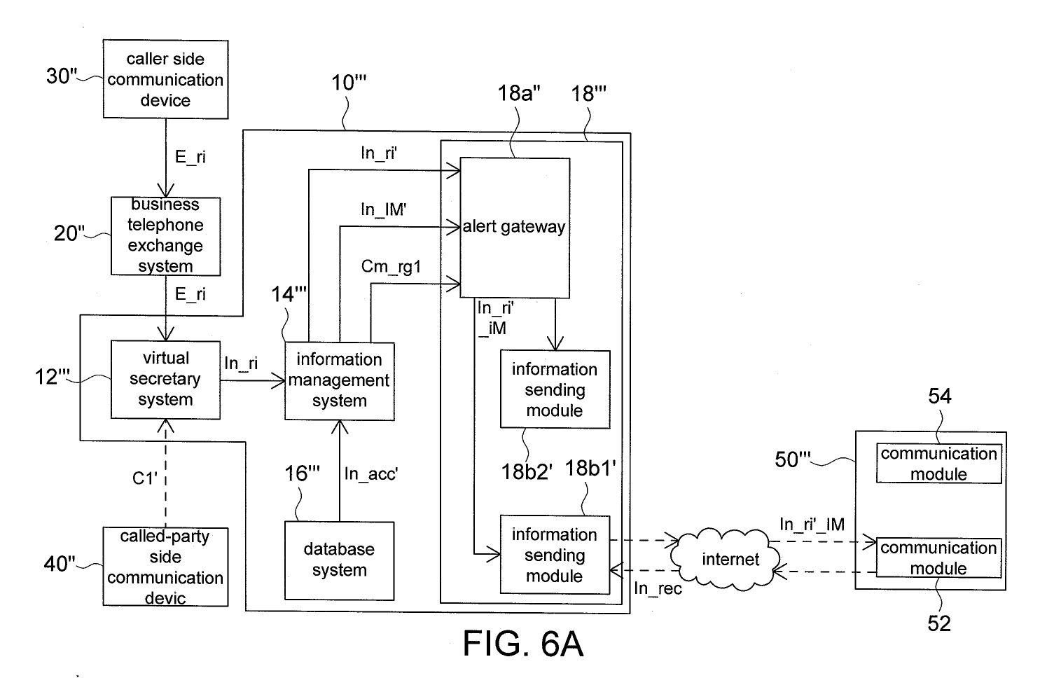

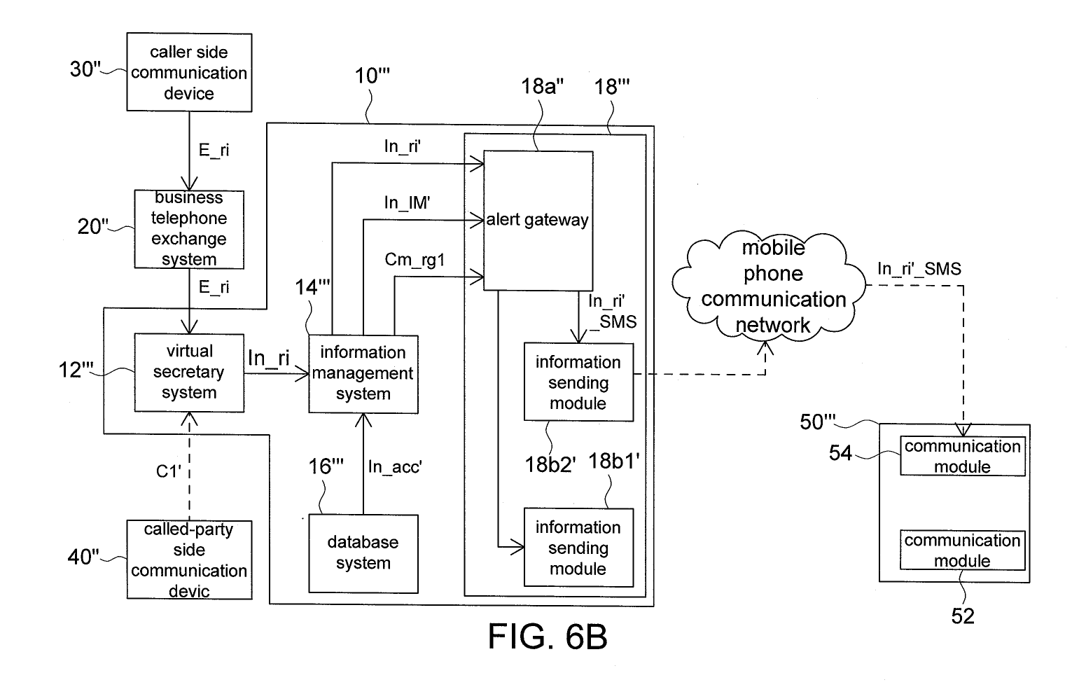

Referring to FIG. 6A and FIG. 6B, another block diagrams of an incoming call information transmission system according to a second embodiment of the invention are shown. In another example of application, the account information In_acc′, for example, includes the information of transmission sequence. The information management system 14′″, according to the information of transmission sequence, determines the transmission sequence of the IM system service and the SMS via which the incoming call information In_ri′ is transmitted. Thus, the information management system 14′″, according to the transmission sequence information, can operate the transmission of the incoming call information In_ri′ via the IM system service, SMS or via the IM system service and the SMS at the same time.

For example, the information management system 14′″, according to the transmission sequence information, determines to operate the transmission of the incoming call information In_ri′ via the IM system service first as indicated in FIG. 6A. In the present example, the communication module 52′, on receiving the incoming call information In_ri′_IM, further sends back an information receiving message In_rec to the information transmission system 18′″ via the IM communication system service, and the information transmission system 18′″ further sends the information the receiving message In_rec back to the information management system 14′″. The information management system 14′″ of the present embodiment of the invention judges whether the operation of transmitting the incoming call information In_ri′ via the IM system service is successful according to whether the information the receiving message In_rec is received in a fixed period of time after the incoming call information In_ri′, the communication account In_IM′ and the request command Cm_rq1 are provided to the information transmission system 18′″.

If the information management system 14′″ does not receive the information receiving message In_rec after the incoming call information In_ri′_IM communication account In_IM′ and the request command Cm_rq1 have been provided to the information transmission system 18′″ for a delay time, the information management system 14′″ judges that the operation of transmitting the incoming call information In_ri′ via the IM system service fails. For example, if the information sending module 18b2′ or the information communication device 50′″ is turned off, the incoming call information transmission system 10′″ is unable to operate transmission with the incoming call information In_ri′ via the IM system service.

The information management system 14′″ of the present embodiment of the invention, after determining that the operation of transmitting the incoming call information In_ri′ via the IM system service fails, further controls the information transmission system 18′″ to transmit the incoming call information In_ri′ via the SMS as indicated in FIG. 6B. Thus, the incoming call information transmission system 10′″ of the present embodiment of the invention changes to transmit the incoming call information In_ri′ via the SMS when the operation of transmitting the incoming call information In_ri′ via the IM system service fails.

In the present embodiment of the invention, the called-party side communication device 40″ and the information communication device 50″ are two independent communication devices. However, the called-party side communication device 40″ and the information communication device 50″ can also be integrated into one multi- module communication device capable of supporting many different communication operations. For example, the multi-module communication device is a smart phone having a network phone module, a mobile phone module and an IM module and supports the communication between the called-party side communication device 40″ and information communication device 50″ of the present embodiment of the invention.

When the called-party side communication device cannot communicate with the first communication system service, the incoming call information transmission system of the present embodiment of the invention transmits the incoming call information to the two or more than two communication accounts via a communication system service corresponding to two or more than two communication accounts. Thus, in comparison to conventional incoming call information management mechanism, the incoming call information transmission system of the invention transmits the incoming call information to the communication device specified by the callee in real time, such that the incoming call information is provided in real time.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An incoming call information transmission system for transmitting incoming call information called to a first communication device via a first communication system service, wherein the incoming call information transmission system comprises:
a virtual secretary system used for recording the incoming call information in response to an incoming call event;
a database system used for storing a first preset account information, wherein the first preset account information corresponds to a first user account of a second communication system service, and the first user account is logged in the server system providing the second communication system service via the second communication device in response to a first operational event;
an information management system used for receiving the incoming call information and getting the first preset account information by looking up the database system, wherein the information management system further generates a first request command; and
an information transmission system used for transmitting the incoming call information to the second communication device via the second communication system service in response to the first request command.

2. The incoming call information transmission system according to claim 1, wherein the second communication device further sends back a receiving message to the information transmission system on receiving the incoming call information;
wherein, after the incoming call information has been transmitted to the second communication device for a delay time, the information transmission system further judges whether the receiving message is received, and if the receiving message is not received, the information transmission system informs the information management system of the erroneous operation in transmitting the incoming call information.

3. The incoming call information transmission system according to claim 1, wherein the database system further stores a second preset account information corresponding to a second user account of a third communication system service, and the second user account is logged in the server system providing the third communication system service via a third communication device in response to a second operational event;
wherein, the information management system further gets the second preset account information by looking up the database system, the information management system further generates a second request command, such that the information transmission system transmits the incoming call information to the third communication device via the third communication system service.

4. The incoming call information transmission system according to claim 3, wherein the second and the third communication device are communication modules disposed in the first communication device for enabling the first communication device to support the communication operation of the second and the third communication system service.

5. The incoming call information transmission system according to claim 4, wherein one of the second and the third communication system service has a regional range, the virtual secretary system judges whether the first communication device is inside the regional range and determines whether to send the incoming call information to the second communication device via the second communication system service or send the incoming call information to the third communication device via the third communication system service.

6. The incoming call information transmission system according to claim 3, wherein the information transmission system comprises:
an alert gateway used for converting the data format of the incoming call information to get a first converted incoming call information in response to the first request command and converting the data format of the incoming call information to get a second converted incoming call information in response to the second request command;
a first information sending module used for receiving the first converted incoming call information and transmitting the first converted incoming call information to the second communication device via the second communication system service; and
a second information sending module used for receiving the second converted incoming call information and transmitting the second converted incoming call information to the third communication device via the third communication system service.

7. The incoming call information transmission system according to claim 3, wherein the third communication system service is an instant message (IM) system service.

8. The incoming call information transmission system according to claim 3, wherein the third communication system service is a short message system (SMS) service.

9. The incoming call information transmission system according to claim 1, wherein the second communication system service is an IM system service.

10. The incoming call information transmission system according to claim 1, wherein the third communication system service is an SMS service.

11. An incoming call information transmission method used for transmitting incoming call information called to a first communication device, wherein the first communication device supports a first communication system service, the method for transmitting incoming call information comprises:
recording the incoming call information in response to an incoming call event;
getting the first preset account information by looking up a database system, wherein the first preset account information corresponds to a first user account of a second communication system service, and the first user account is logged in the server system providing the second communication system service via a second communication device; and
sending the incoming call information to the second communication device via the second communication system service.

12. The incoming call information transmission method according to claim 11, further comprising:
sending back a receiving message on receiving the incoming call information; and
judging whether erroneous operation occurs to the transmission of the incoming call information according to whether the receiving message is received.

13. The incoming call information transmission method according to claim 11, further comprising:
getting a second preset account information by looking up the database system, wherein the second preset account information corresponds to a second user account of a third communication system service, and the second user account is logged in the server system providing the third communication system service via a third communication device; and
transmitting the incoming call information to the third communication device via the third communication system service.

14. The incoming call information transmission method according to claim 11, wherein the second communication system service has a regional range.

15. The incoming call information transmission method according to claim 14, further comprising:
judging whether the second communication device is inside the regional range and determining whether to transmit the incoming call information to the second communication device via the second communication system service or transmit the incoming call information to the third communication device via the third communication system service.

16. The incoming call information transmission method according to claim 11, wherein the third communication system service has a regional range.

17. The incoming call information transmission method according to claim 16, further comprising:
judging whether the third communication device is inside the regional range and determining whether to transmit the incoming call information to the second communication device via the second communication system service or transmit the incoming call information to the third communication device via the third communication system service.
